(19) United States
(12) Patent Application Publication
(10) Pub. No.: US 2011/0257800 A1
(43) Pub. Date: Oct. 20, 2011

(54) Particle swarm optimizing sliding mode controller

(76) Inventors: Zakariya Al-Hamouz, (US); Hussain N. Al-Duwaish, (US); Naji A. Al-Musabi, Abu Dhabi (AE)

(21) Appl. No.: 12/662,378

(22) Filed: Apr. 14, 2010

(51) Int. Cl. G05B 13/04; G06F 1/28; G05B 13/02

(52) U.S. Cl. 700/287; 700/32; 700/29

(57) ABSTRACT

The particle swarm optimizing sliding mode controller is applied to an interconnected Automatic Generation Control (AGC) model. The system formulates the SMC design as an optimization problem and utilizes a Particle Swarm Optimization (PSO) algorithm to find the optimal feedback gains and switching vector values of the controller. Two performance functions are used in the optimization process to demonstrate the system dynamical performance and SMC chattering reduction. The tested two-area interconnected AGC model incorporates nonlinearities in terms of Generation Rate Constraint (GRC) and a limiter on the integral control value.

### BACKGROUND OF THE INVENTION

1. Field of the Invention

The present invention relates generally to interconnected power generation systems, and more specifically, to a particle swarm optimizing sliding mode controller having a control optimization feature that reduces chattering in the responses of the interconnected power generation systems.

2. Description of the Related Art

The Automatic Generation Control (AGC) problem has been one of the most important issues in the operation and design of contemporary electric power systems. This importance is due to the role of the AGC in securing a satisfactory operation of power systems and ensuring constancy of speed for induction and synchronous motors, thereby improving the performance of generating units. The purpose of AGC is to track load variation while maintaining system frequency and tie line power interchanges (for interconnected areas) close to specified values. In this way, transient errors in frequency and tie line power should be minimized and steady error should not appear.

In the last two decades, many techniques were proposed for the supplementary control of AGC systems. Conventionally, Proportional Integral (PI) and Proportional Integral Derivative (PID) controllers are used for AGC. However, PI has many drawbacks, some of which are long settling time and relatively large overshoots in the transient frequency deviations. Furthermore, utilization of optimal control theory has been examined. The controller design is normally based on the parameters of the linear incremental model of the power system, which, in turn, depend on the condition of the power system. Therefore, the linear optimal controller is sensitive to variations in the plant parameters or operating conditions of the power system. Moreover, the linear optimal controller yields unsatisfactory dynamic response in the presence of Generation Rate Constraint (GRC). Other techniques used for designing the secondary control loop for the AGC include Neural Network methods, Superconducting Magnetic Energy Storage (SMES) unit applications and spline techniques. Furthermore, the application of the Sliding Mode Controller (SMC) to the AGC problem has already been considered in the art. SMC possesses some attractive features, mainly robustness and good transient response. As is known by those having ordinary skill in the art, a SM controller has been compared with conventional and optimal control methods for two equal area non-reheat and reheat thermal systems.

However, a systematic method for obtaining the switching vector and optimum feedback gain of the SMC has yet to be considered. Pole placement technique has been utilized in designing the SMC for a single area non-reheat AGC system in known prior experimentation in which the feedback gains were selected by trial and error.

In practice, AGC models are nonlinear. Unfortunately, conventional control design methods are not efficient when nonlinearities are introduced to the incremental models of control systems. Thus, other methods should be utilized for the design of the controllers. One of the most reliable techniques is the use of iterative, heuristic optimization algorithms, which can be used to tune the controllers to obtain their optimum settings. Some of the recent attempts that utilize the iterative heuristic algorithms for solving the AGC problems (for linearized models) can be found in previous work of the present inventor, where a Genetic Algorithm (GA) was used to optimize only the feedback gains of the SMC applied to a single area, non-reheat AGC. On the other hand, Particle Swarm Optimization (PSO) has used for the same purpose, and for a single area linear model, too, but there is still a need to have a systematic method for obtaining the switching vector and optimizing feedback gain of the SMC when using PSO.

Thus, a particle swarm optimizing sliding mode controller solving the aforementioned problems is desired.

### SUMMARY OF THE INVENTION

The particle swarm optimizing sliding mode controller provides a sliding mode controller (SMC) with a chattering reduction feature applied to an interconnected Automatic Generation Control (AGC) model. The controller uses a method that formulates the design of SMC as an optimization problem and utilizes a Particle Swarm Optimization (PSO) algorithm to find the optimal feedback gains and switching vector values of the controller. Two performance functions are used in the optimization process to demonstrate the system dynamical performance and SMC chattering reduction. The tested two-area interconnected AGC model incorporates nonlinearities in terms of Generation Rate Constraint (GRC) and a limiter on the integral control value. Comparison with a previous AGC methods reported in literature validates the significance of the SMC design.

These and other features of the present invention will become readily apparent upon further review of the following specification and drawings.

### BRIEF DESCRIPTION OF THE DRAWINGS

FIG. 1 is a block diagram showing interconnected power systems that can be controlled by a particle swarm optimizing sliding mode controller according to the present invention.

FIG. 2A is a block diagram of a particle swarm optimizing sliding mode controller according to the present invention.

FIG. 2B is a flowchart showing the particle swarm generation portion of a particle swarm optimizing sliding mode controller according to the present invention.

FIG. 2C is a flowchart showing the PSO-based design procedure for the optimal selection of feedback gains and switching vectors in a particle swarm optimizing sliding mode controller according to the present invention.

FIG. 3 is a plot showing convergence of the two objective functions J1 and J2 in a particle swarm optimizing sliding mode controller according to the present invention.

FIG. 4 shows a plot of frequency deviation in area 1 when using particle swarm optimizing sliding mode controllers according to the present invention as compared to an LQR controller.

FIG. 5 is a plot showing frequency deviation in area 2 when using particle swarm optimizing sliding mode controllers according to the present invention as compared to an LQR controller.

FIG. 6 is a plot showing tie-line power deviation when using particle swarm optimizing sliding mode controllers according to the present invention as compared to an LQR controller.

FIG. 7A is a plot showing control signals (efforts) when using the objective performance function J₁ with input u1 in a particle swarm optimizing sliding mode controller according to the present invention.

FIG. 7B is a plot showing control signals (efforts) when using the objective performance function J₁ with input u2 in a particle swarm optimizing sliding mode controller according to the present invention.

FIG. 8A is a plot showing control signals (efforts) when using the objective performance function J₂ with input u1 in a particle swarm optimizing sliding mode controller according to the present invention.

FIG. 8B is a plot showing control signals (efforts) when using the objective performance function J₂ with input u2 in a particle swarm optimizing sliding mode controller according to the present invention.

FIG. 9 is a plot showing the effect of system parameters variation on frequency deviation in area 1 for a particle swarm optimizing sliding mode controller according to the present invention.

FIG. 10 is a plot showing the effect of system parameters variation on frequency deviation in area 2 for a particle swarm optimizing sliding mode controller according to the present invention.

FIG. 11 is a plot showing the effect of system parameters variation on tie-line power deviation for a particle swarm optimizing sliding mode controller according to the present invention.

Similar reference characters denote corresponding features consistently throughout the attached drawings.

### DETAILED DESCRIPTION OF THE PREFERRED EMBODIMENTS

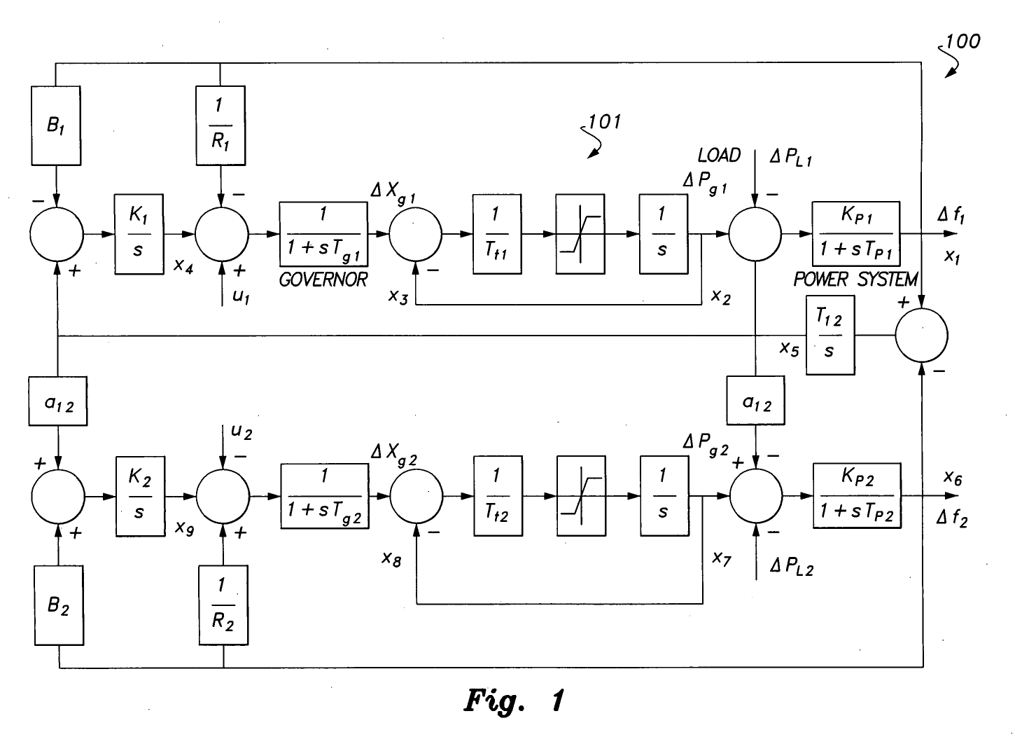

The particle swarm optimizing sliding mode controller provides a system for controlling two non-linearly interconnected power generation systems. As shown in FIG. 1, the interconnected power generation systems 100 may include steam turbine generator subsystems 101, which function as the prime movers for the electrical power generators. The model includes the effect of Generation Rate Constraint (GRC) and limits on the position of the governor valve, which are caused by the mechanical and thermodynamic constraints in practical steam turbine systems. In addition, a limiter on the integral control value is included to prevent excessive control. A typical value of 0.015 per unit/min (p.u./min) has been included in the model. Tₚ is the plant model time constant, Tᵣ is the turbine time constant, T_{g} is the governor time constant, Kₚ (Hz/p.u. MW) is the plant gain, K is the integral control gain, and R (Hz/p.u. MW) is the speed regulation due to governor action. x₂, x₃, and x₄ are respectively the incremental changes in generator output (p.u. MW), governor valve position (p.u. MW) and integral control of area 1.

The tie line power is x₅. On the other hand, x₇, x₈, and x₉ are, respectively, the incremental changes in generator output (p.u. MW), governor valve position (p.u. MW), and integral control of area 2. The control objective in the AGC problem is to keep the change in frequencies (Hz) Δf₁=x₁ and Δf₂=x₂, as well as the change in tie-line power ΔPₜᵢₑ=x₉, as close to zero as possible when the system is subjected to load disturbance ΔP_{L1} and ΔP_{L2} by manipulating the inputs u₁ and u₂, respectively. The values of the parameters used for the interconnected system are as in Table 1.

TABLE 1
Interconnected system parameters

| | |
|---|---|
| T_{P1} = Tₚ₂ = 20 s | Kₚ₁ = Kₚ₂ = 120 Hz p.u. MW⁻¹ |
| Tₜ₁ = Tₜ₂ = 0.3 s | K₁ = K₂ = 1 p.u. MW rad⁻¹ |
| T_{g1} = T_{g2} = 0.08 s | R₁ = R₂ = 2.4 Hz p.u. MW⁻¹ |
| B₁ = B₂ = 0.425 p.u. MW/Hz | T₁₂ = 0.545 p.u. MW |
| a₁₂ = −1 | GRC (Generation rate |
| | constraint) = 0.015 |

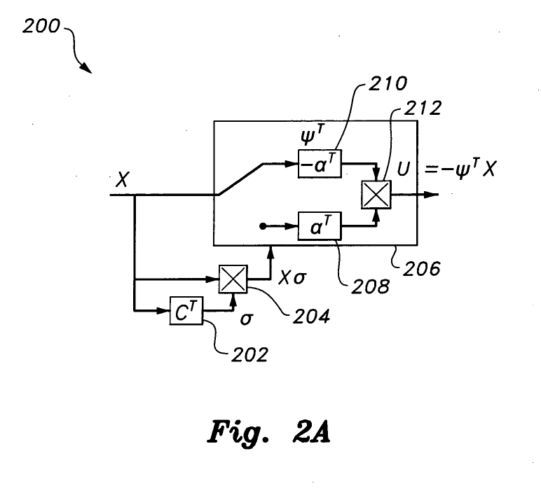

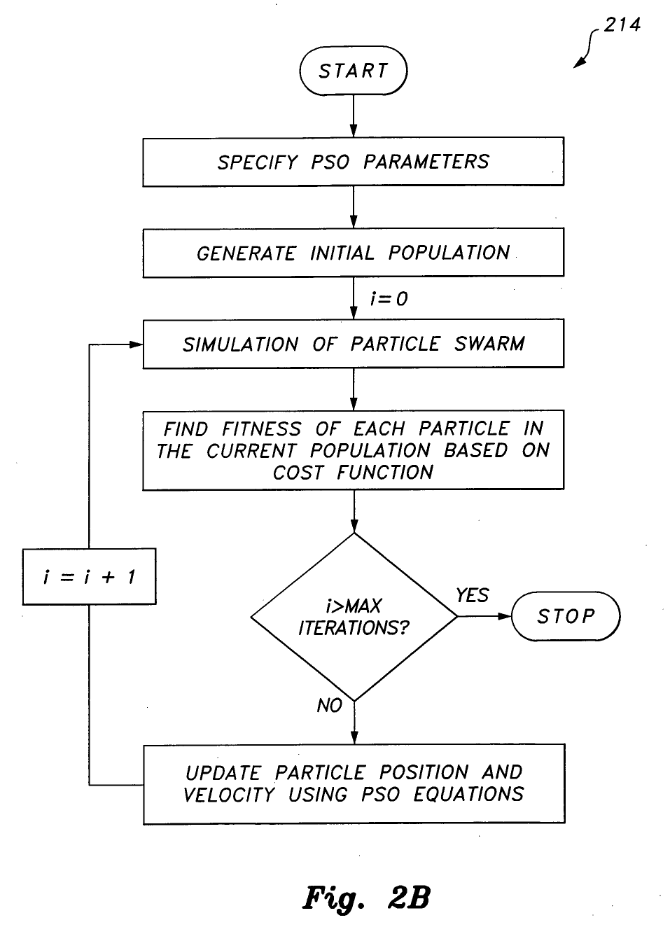

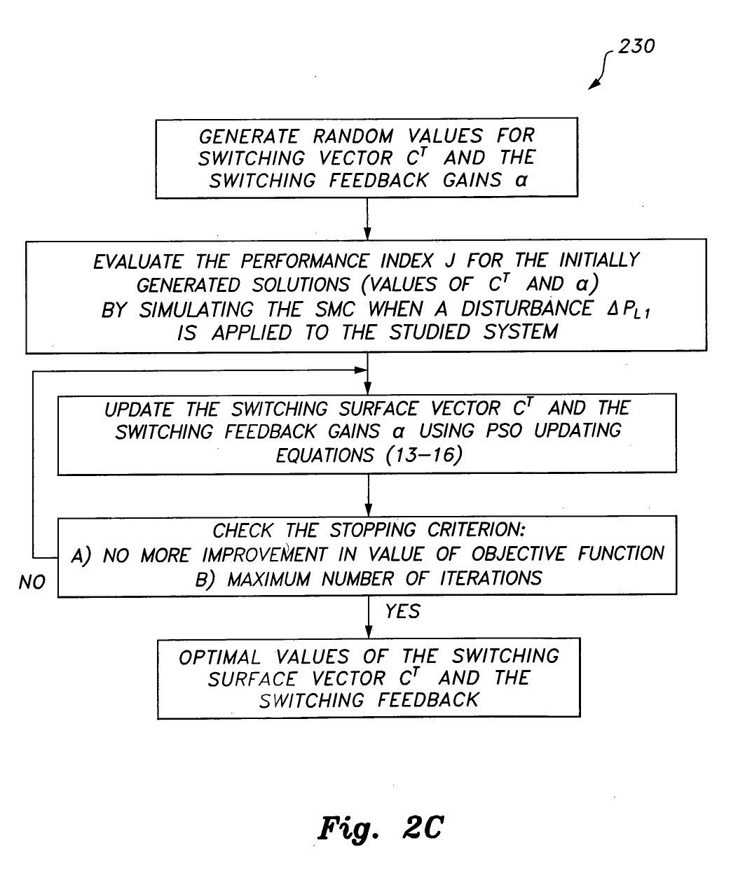

The fundamental theory of the SMC is well known to persons having ordinary skill in the art. Different control goals, such as stabilization, tracking, and regulation, can be achieved using SMC by the proper design of the sliding surface. The regulation problem is addressed wherein the objective is to keep specified states as close to zero as possible. A block diagram of the SMC 200 for the regulation problem is shown in FIG. 2A. The output U 212 switches between values having −α^{T} 210 and +α^{T} 208 based on input X, switching vectors C^{T} 202, and their product 204. The control law is a linear state feedback whose coefficients are piecewise constant functions. Consider the linear time-invariant controllable system given by:

\dot{x}(t)=AX(t)+BU(t) (1)

where:

X(t) is an n-dimensional state vector;

U(t) is an m-dimensional control force vector;

A is an n×n system matrix, and

B is an n×m input matrix.

The SMC control laws for the system of (1) are given by:

$${u}_{i} = - {ψ}_{i}^{T} X = - {\sum }_{j = 1}^{n} {ψ}_{ij} {x}_{j} ; i = 1 , 2 , … , m \qquad ( 2 )$$

where the feedback gains are given as:

$${ψ}_{ij} = \{ \begin{matrix}{α}_{ij} , & if {x}_{i} {σ}_{j} > 0 \\ - {α}_{ij} , & if {x}_{j} {σ}_{i} < 0\end{matrix} i = 1 , … , m ; j = 0 , … , n \\ and \\ {σ}_{i} ( X ) = {C}_{i}^{T} X = 0 , i = 1 , … , m \qquad ( 3 )$$

where cᵢ's are the switching vectors that are selected by pole placement or linear optimal control theory.

The design procedure for selecting the constant switching vectors cᵢ using pole placement includes a procedure that defines the coordinate transformation:

Y=MX (4)

such that:

$$MB = [ \begin{matrix}0 \\ ⋯ \\ {B}_{2}\end{matrix} ] \qquad ( 5 )$$

where M is a nonsingular m×n matrix and B₂ is a nonsingular m×m matrix. Then, from (4) and (5), calculating:

$$\begin{matrix}\dot{Y} = M \dot{X} = {MAM}^{- 1} Y + M B U & ( 6 ) \\ [ \begin{matrix}{\dot{Y}}_{1} \\ {\dot{Y}}_{2}\end{matrix} ] = [ \begin{matrix}{A}_{11} & {A}_{12} \\ {A}_{21} & {A}_{22}\end{matrix} ] [ \begin{matrix}{Y}_{1} \\ {Y}_{2}\end{matrix} ] + [ \begin{matrix}0 \\ {B}_{2}\end{matrix} ] U & ( 7 )\end{matrix}$$

where A₁₁, A₁₂, A₂₁, A₂₂ are respectively (n−m)×(n−m), (n−m)×m, m×(n−m) and (m×m) submatrices. The first equation of (7), together with (3), specifies the motion of the system in the sliding mode, which is:

\dot{Y}₁=A₁₁Y₁+A₁₂Y₂ (8)

Σ(Y)=C₁₁Y₁+C₁₂Y₂ (9)

where c₁₁ and c₁₂ are m×(n−m) and (m×m) matrices, respectively satisfying the relation:

[c₁₁c₁₂]=c^{T}M⁻¹ (10)

Equations (8) and (9) uniquely determine the dynamics in the sliding mode over the intersection of the switching hyper-planes.

The subsystem described by (8) may be regarded as an open loop control system with state vector Y₁ and control vector Y₂ being determined by (9), that is:

Y₂=C₁₂⁻¹C₁₁Y₁ (11)

Consequently, the problem of designing a system with desirable properties in the sliding mode can be regarded as a linear feedback design problem. Therefore, it can be assumed, without loss of generality, that c₁₂=an identity matrix of proper dimension. Next, equations (8) and (11) can be combined to obtain:

\dot{Y}₁=[A₁₁−A₁₂C₁₁]Y₁ (12)

It is well know in the art that if the pair (A, B) is controllable, then the pair (A₁₁, A₁₂) is also controllable. If the pair (A₁₁, A₁₂) is controllable, then the eigenvalues of the matrix [A₁₁−A₁₂C₁₁] in the sliding mode can be placed arbitrarily by suitable choice of C₁₁. The feedback gains αᵢⱼ are usually determined by simulating the control system and trying different values until satisfactory performance is obtained.

Particle Swarm Optimization (PSO) is an evolutionary computation technique inspired by social behavior and bird flocking or fish schooling. As shown in FIG. 2B, the steps of the PSO algorithm 214 include initializing a population (array) of particles with random positions and velocities v on d dimension in the problem space. The particles are generated by randomly selecting a value with uniform probability over the d^{th} optimized search space [x_{d}^{min},x_{d}^{max}]. The time counter is set t=0.

For each particle x, the desired optimization fitness function, J, is evaluated in d variables.

Then the procedure compares particle fitness evaluation with x_{pbest}, which is the particle with best local fitness value. If the current value is better than that of x_{pbest}, then set x_{pbest} equal to the current value, and X_{pbest} locations equal to the current locations in d-dimensional space.

Next, compare fitness evaluation with population overall previous best. If the current value is better than gbest, the global best fitness value, then reset x_{gbest} to the current particle's array index and value.

Update the time counter t, inertia weight w, velocity v, and position of x according to the following equations:

$$\begin{matrix} t = t + 1 & ( 13 ) \\ w ( t ) = {w}_{min} + ( {w}_{max} - {w}_{min} ( \frac{m - t}{m - 1} ) ) & ( 14 ) \\ {v}_{ia} ( t ) = w ( t ) {v}_{id} ( t - 1 ) + 2 α ( {x}_{idpbest} ( t - 1 ) - {x}_{id} ( t - 1 ) ) + 2 α ( {x}_{idgbest} ( t - 1 ) - {x}_{id} ( t - 1 ) ) & ( 15 ) \\ {x}_{id} ( t ) = {v}_{id} ( t ) + {x}_{id} ( t - 1 ) & ( 16 )\end{matrix}$$

where wₘᵢₙ and wₘₐₓ are the maximum and minimum values of the inertia weight w, m is the maximum number of iterations, i is the number of the particles that goes from 1 to n, d is the dimension of the variables, and α is a uniformly distributed random number in (0,1). The particle velocity in the d^{th} dimension is limited by some maximum value v_{d}^{max}. This limit improves max the exploration of the problem space. In this study, v_{d}^{max} is proposed as:

v_{d}^{max}=kx_{d}^{max} (17)

where k is a small constant value chosen by the user, usually between 0.1-0.2 of x_{d}^{max}.

Loop to the particle swarm simulation step until a criterion is met, such as a good fitness value or a maximum number of iterations (generations).

The nonlinear interconnected AGC model has nine state variables and two control inputs. The switching vector of the sliding mode controller is represented by:

$${C}^{T} = [ \begin{matrix}{c}_{11} & {c}_{12} & {c}_{13} & {c}_{14} & {c}_{15} & {c}_{16} & {c}_{17} & {c}_{18} & {c}_{19} \\ {c}_{21} & {c}_{22} & {c}_{23} & {c}_{24} & {c}_{25} & {c}_{26} & {c}_{27} & {c}_{28} & {c}_{29}\end{matrix} ]$$

and the feedback gains are given by:

$$α = [ \begin{matrix}{α}_{11} & {α}_{12} & {α}_{13} & {α}_{14} & {α}_{15} & {α}_{16} & {α}_{17} & {α}_{18} & {α}_{19} \\ {α}_{21} & {α}_{22} & {α}_{23} & {α}_{24} & {α}_{25} & {α}_{26} & {α}_{27} & {α}_{28} & {α}_{29}\end{matrix} ]$$

This will result in a total of 36 parameters to be optimized using the PSO based approach. As shown in FIG. 2C, the PSO-based design procedure 230 for the optimal selection of the feedback gains and switching vectors is as follows: (1) generate randomly a set of possible feedback gains represented by on α₁₁, . . . , α₂₉ and switching vector c₁₁, . . . , c₂₉; (2) simulate the system in FIG. 1 after applying a step load disturbance at ΔP_{L1} and record Δω₁(t), Δω₂(t) and ΔPₜᵢₑ(t) for the entire simulation time; and (3) evaluate a performance index for the feedback gains α₁₁, . . . , α₂₉ and switching vector values c₁₁, . . . , c₂₉ generated in step 1. The following performance index is used:

$${J}_{1} = {\int }_{0}^{∞} 0.75 t \vert {Δω}_{1} \vert + t \vert {Δω}_{2} \vert + 0.5 t \vert Δ {P}_{tie} \vert d t \qquad ( 18 )$$

This performance index puts emphasis on improving the dynamical behavior of the AGC system. This has been done by including the absolute error time of the internal parameters of the AGC system into the performance index. Furthermore, to reduce chattering from the control signal, the controller provides a second performance index J₂, which includes the deviation of the control effort:

$${J}_{2} = {\int }_{0}^{∞} {Δω}_{1}^{2} + {Δω}_{2}^{2} + Δ {P}_{tie}^{2} + Δ {u}_{i}^{2} + Δ {u}_{2}^{2} d t \qquad ( 19 )$$

Continuing with the procedure of FIG. 2C, (4) based on the value of the performance index, use the aforementioned particle swarm optimizer (PSO), to generate new feedback gains and switching vector values; and (5) evaluate the performance index in step (2) for the new feedback gains and switching vector values. Stop if there is no more improvement in the value of the performance index or if the maximum number of iterations has been used. Otherwise, go back to step (3).

The inventors have compared the particle swarm optimizing sliding mode controller with a Linear Quadratic Regulator (LQR)-based system for two area interconnected nonlinear power systems. The sliding mode controller uses PSO for the selection of the optimum gains of this integral controller. The optimum gains are K₁=0.5512 and K₂=0.01. The PSO settings used are: number of particles=15; maximum number of iterations=500; wₘₐₓ=0.9; wₘᵢₙ=0.4; and the maximum velocity constant factor k=0.1.

On the other hand, for the SMC, the optimum switching vector values and feedback gains were found to be as follows:

i) For objective function J₁:

$${C}_{1}^{T} = [ \begin{matrix}30.0000 & 13.0638 & 4.8552 & 24.9203 & 17.8597 & - 3.0000 & - 3.0000 & 4.9979 & - 3.0000 \\ 12.0642 & 17.4207 & 3.4430 & 23.6198 & 13.0664 & 17.6442 & 30.0000 & 5.8677 & 18.7206\end{matrix} ]$$

$${α}_{1} = [ \begin{matrix}3.3757 & 0.0010 & 4.5620 & 0.0010 & 7.4638 & 2.4800 & 0.0010 & 4.7885 & 1.2752 \\ 0.0010 & 0.0010 & 0.0010 & 1.8695 & 5.4026 & 5.5483 & 8.6752 & 0.0010 & 5.8926\end{matrix} ]$$

ii) For objective function J₂:

$${C}_{2}^{T} = [ \begin{matrix}17.5282 & 23.4810 & 1.6520 & 16.5393 & 24.5775 & 6.4494 & 13.9074 & 7.1777 & 30.0000 \\ 13.5409 & 3.1294 & 2.8040 & - 2.8377 & 23.3587 & 2.0022 & 4.0492 & 12.0614 & 22.2385\end{matrix} ]$$

$${α}_{2} = [ \begin{matrix}5.3594 & 0.0697 & 0.0010 & 5.0151 & 1.3586 & 0.0010 & 5.8891 & 4.3556 & 2.8171 \\ 0.0010 & 9.0000 & 0.0010 & 8.9998 & 5.8002 & 0.1515 & 0.1642 & 9.0000 & 9.0000\end{matrix} ]$$

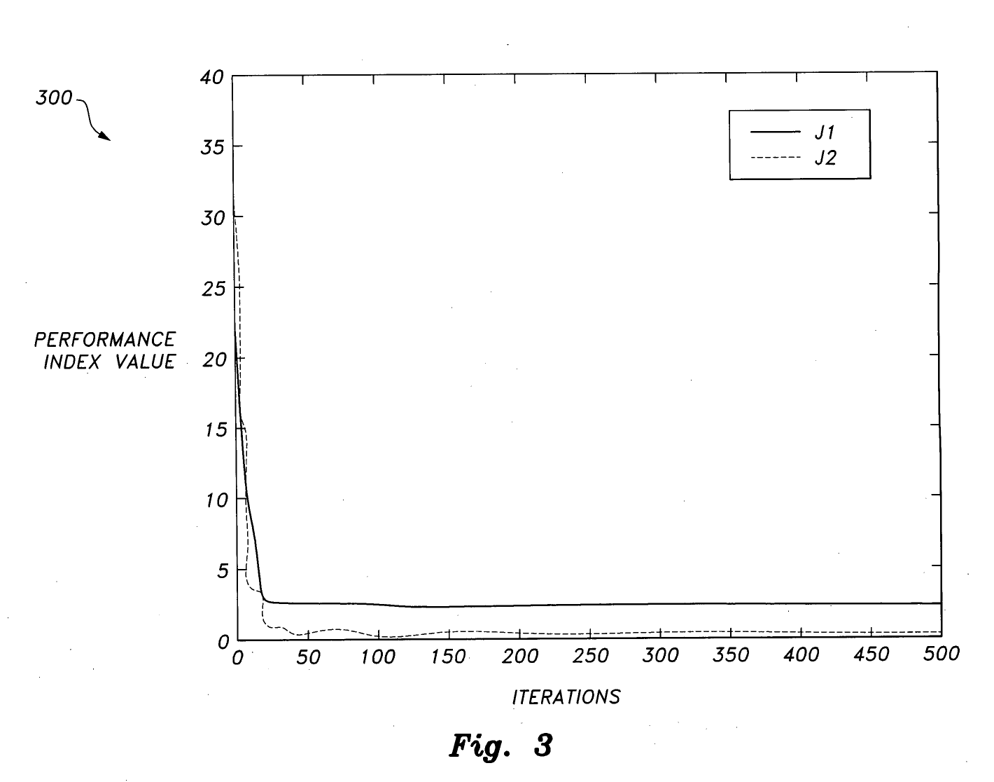

After getting the above SMC parameters, the system is simulated for a 0.01 p.u. load disturbance in area 1. The fast convergence of the objective functions J₁ and J₂ are shown in plot 300 of FIG. 3.

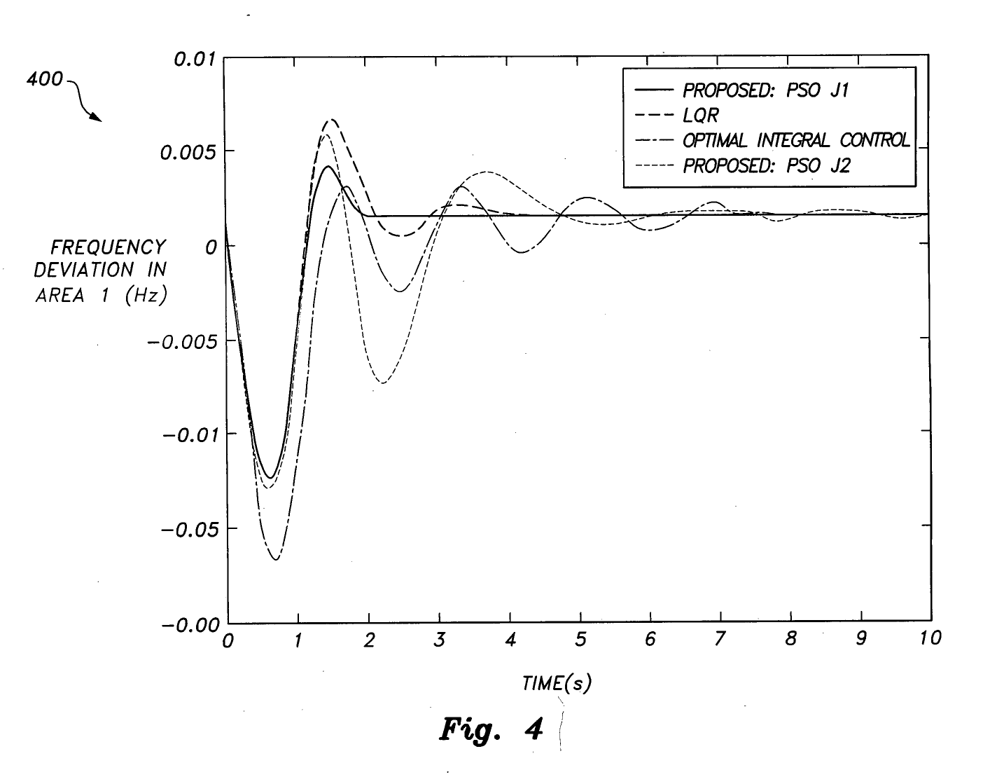

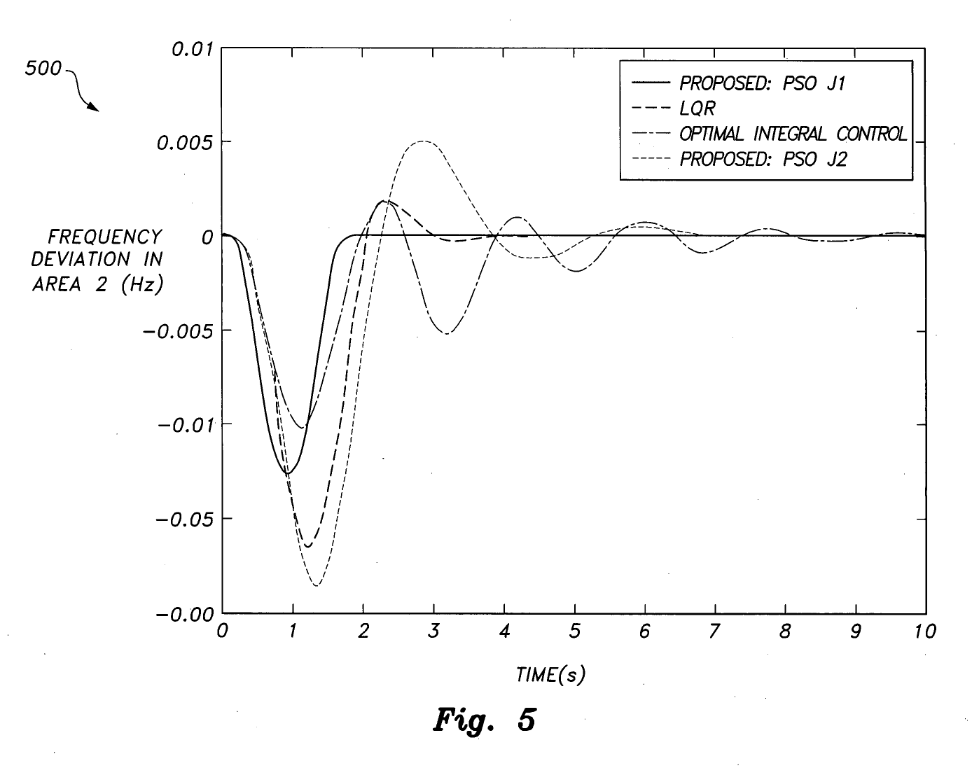

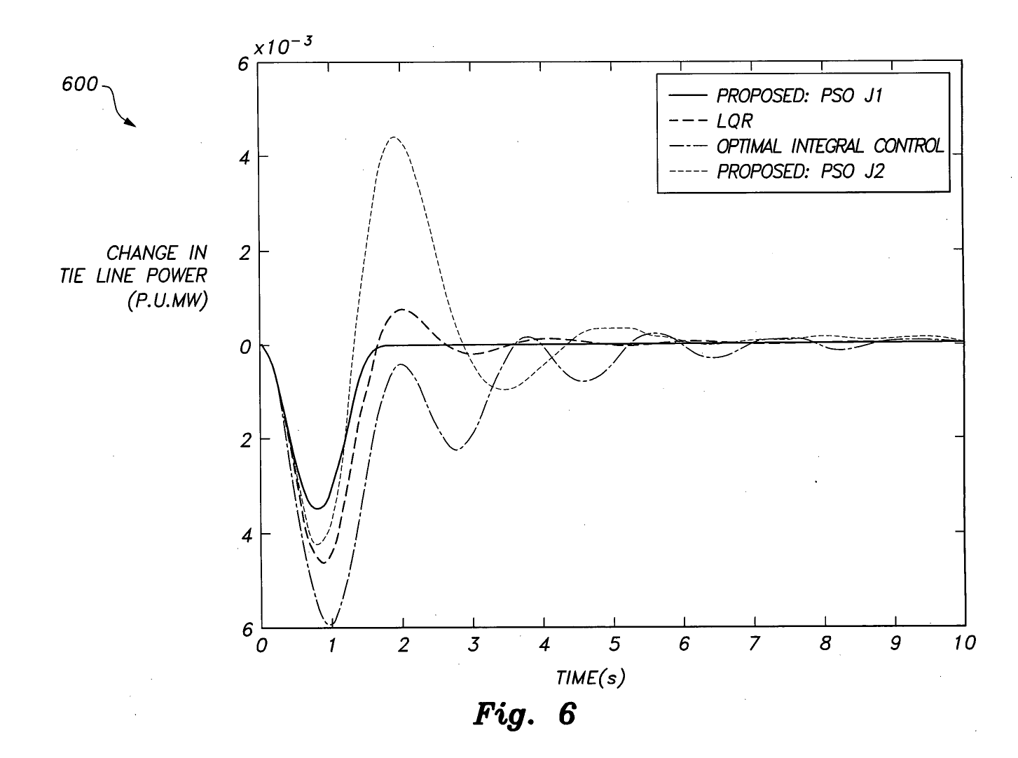

The frequency deviation in areas 1 and 2, as well as the tie-line power change of the interconnected system as compared to prior art methodologies (the LQR model) and the present optimal integral control, are shown in plots 400, 500, and 600 of FIGS. 4-6, respectively.

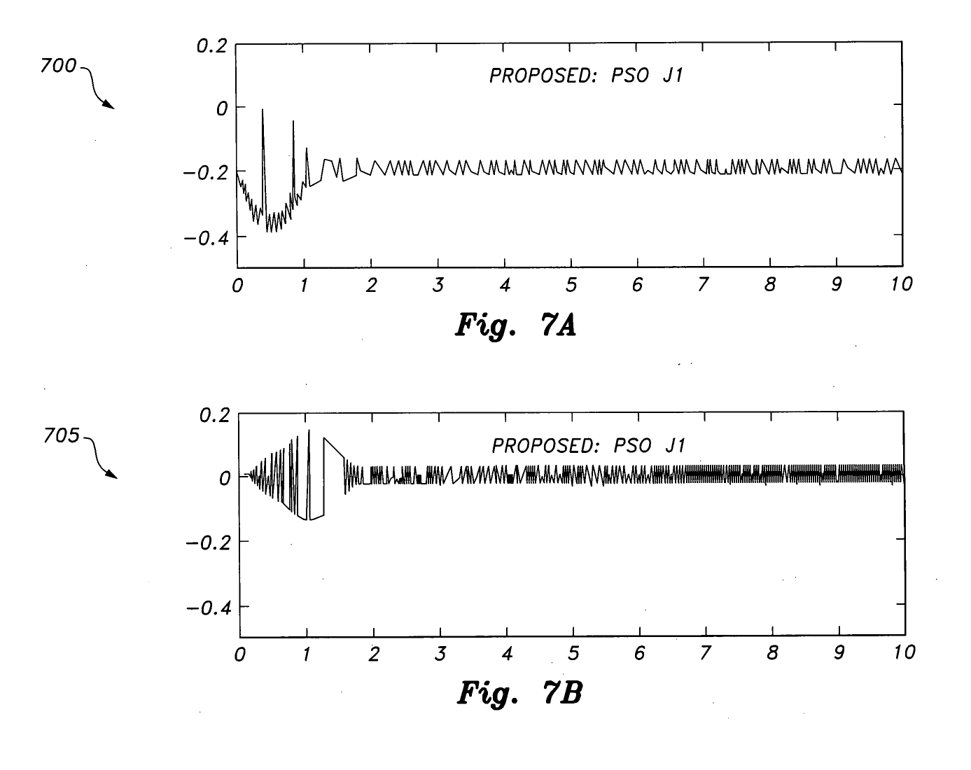

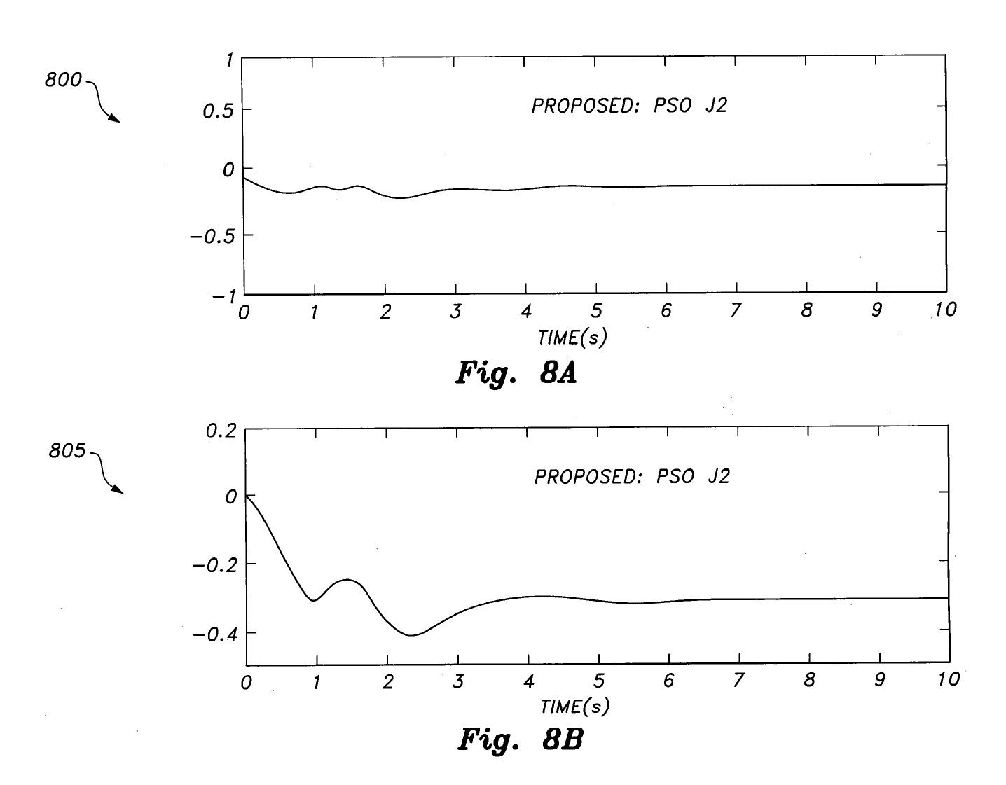

It is quite clear that using J as a performance function allows the design of a SMC controller with improved dynamic behavior, as seen in FIGS. 4-6. This is at the expense of increased fluctuations (chattering) in the control effort u1 plot 700 and control effort u2 plot 705, as seen in FIGS. 7A and 7B, respectively. On the other hand, plots 800 and 805 of FIGS. 8A and 8B, respectively show that including the deviation of the control effort into the performance function, as in J2, reduced dramatically the chattering in the control signal (effort). This reduction in the chattering is at the expense of degradation (but still acceptable) in the dynamical behavior of the interconnected systems, as seen in the comparison of FIGS. 4-6.

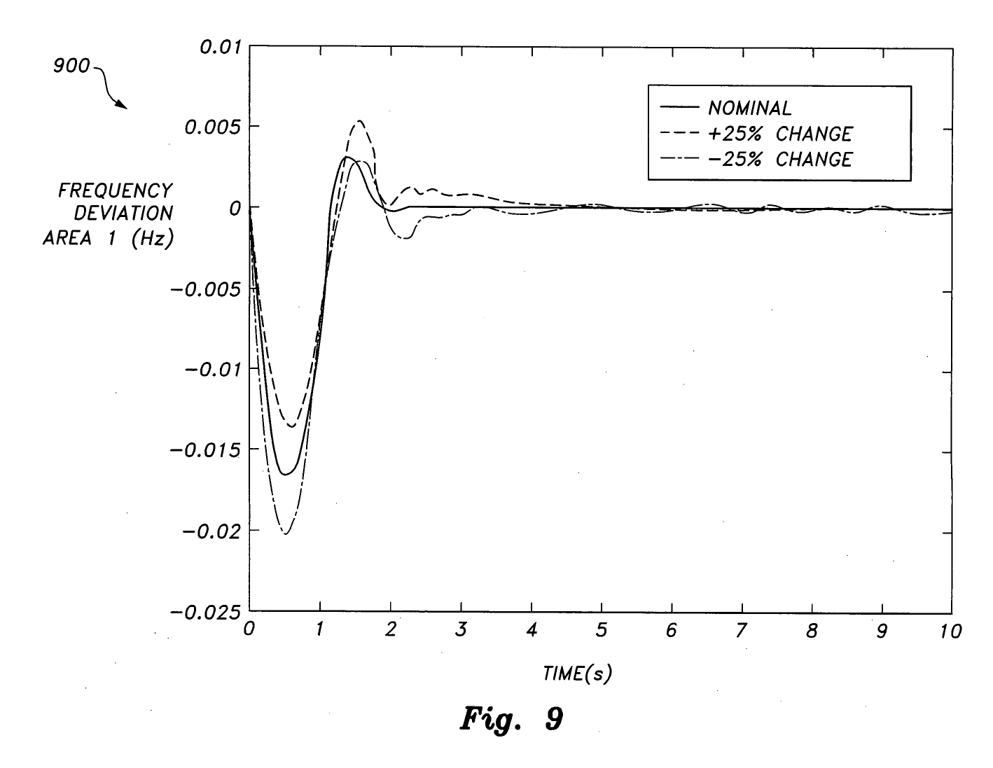

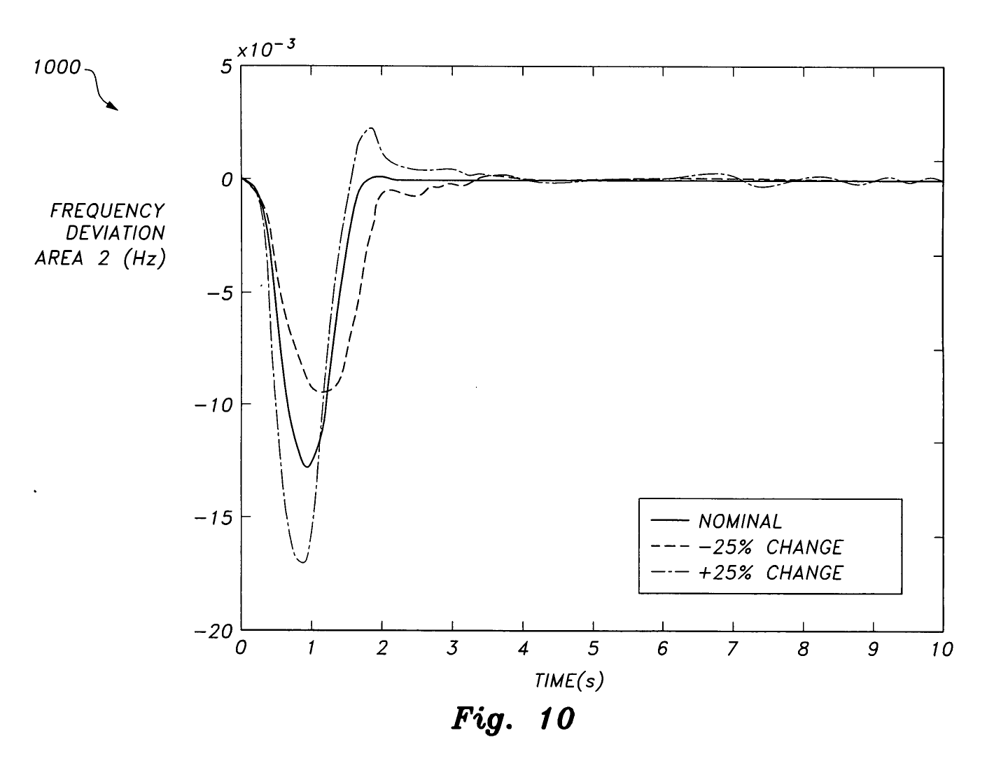

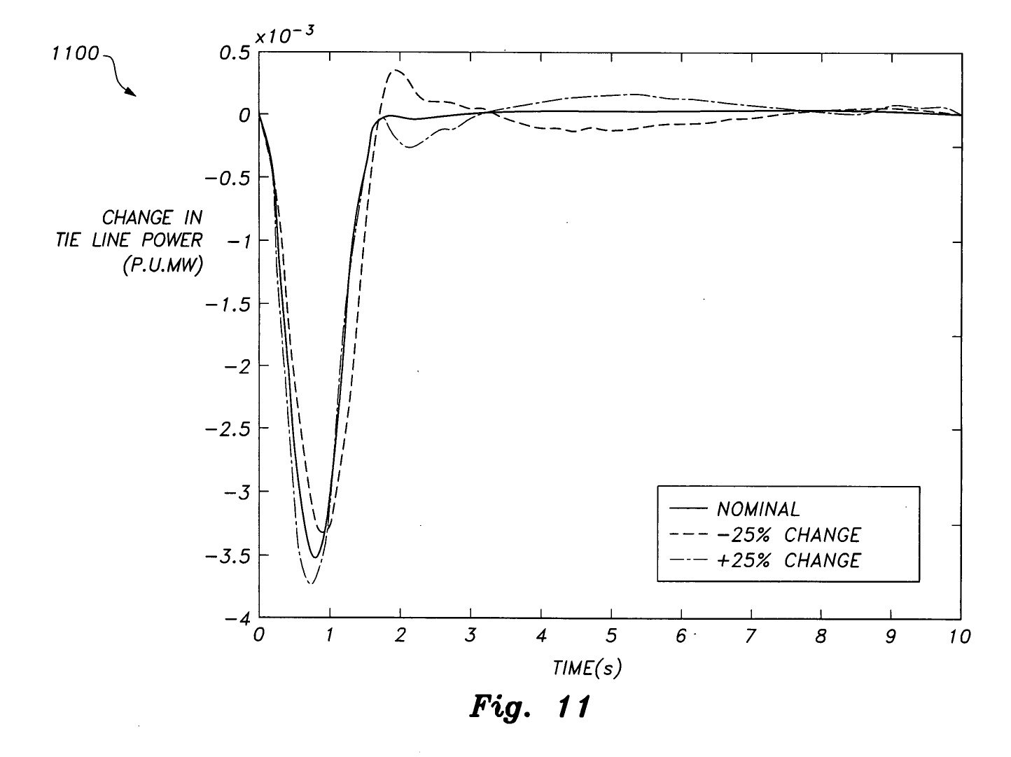

In order to test the robustness of the controller, the model parameters Tₚ₁, Tₚ₂, T_{g1}, T_{g2}, Kₚ₁, and Kₚ₂ were changed by ±25%. The controller feedback gains and switching vector values obtained before when taking J₁ as an objective function are kept the same. The dynamical behavior of the controller under the 0.01 p.u. load disturbance in area 1 is shown in plots 900, 1000, and 1100 of FIGS. 9, 10, and 11, respectively, for frequency deviation in areas 1, and 2 and the tie line power change, respectively. From these figures, it is quite clear that the controller has a satisfactory performance in terms of robustness against model parameter variations. The performance of the particle swarm optimizing SMC controller when J2 was used showed a similar performance and, hence, is not reported.

An efficient sliding mode controller with a chattering reduction feature has been disclosed herein. The optimal feedback gains and switching vector values of the controller are selected based on formulating the SMC design procedure as an optimization problem. A particle swarm optimization algorithm is used as an optimization tool.

The controller has been applied effectively on a practical two-area AGC problem with nonlinearities in the model. The dynamical performance of the system when using the controller is highly enhanced as compared to the dynamics when using previous controllers. The chattering in the control efforts have been successfully eliminated using a new performance function. In addition, the controller has been found to be robust against parameter variations of the model.

It is to be understood that the present invention is not limited to the embodiment described above, but encompasses any and all embodiments within the scope of the following claims.

We claim:

1. A particle swarm optimizing sliding mode controller, comprising:
a circuit under control;
a sliding mode controller connected to the circuit under control, the sliding mode controller having a feedback circuit sending a first set of control signals to the circuit under control, thereby controlling a first set of parameters associated with the circuit under control; and
a particle swarm optimizer connected to the sliding mode controller, the particle swarm optimizer sending a second set of control signals to the sliding mode controller, thereby controlling a second set of parameters associated with the sliding mode controller;
wherein the first set of parameters associated with the circuit under control are controlled in an efficient manner, reducing chattering of the first and the second control signals.

2. The particle swarm optimizing sliding mode controller according to claim 1, wherein said particle swarm optimizer further comprises means for optimally selecting feedback gains associated with the feedback circuit of said sliding mode controller.

3. The particle swarm optimizing sliding mode controller according to claim 2, wherein said particle swarm optimizer further comprises means for optimally selecting a switching vector associated with said sliding mode controller.

4. The particle swarm optimizing sliding mode controller according to claim 3, wherein said particle swarm optimizer further comprises means for defining a performance index thereof so that when the performance index is minimized, chattering the control signals is reduced.

5. The particle swarm optimizing sliding mode controller according to claim 4, wherein said particle swarm optimizer further comprises:
means for generating random values for the switching vector and the switching feedback gains; and
means for evaluating said performance index for the random generated values for the switching vector and the switching feedback gains.

6. The particle swarm optimizing sliding mode controller according to claim 5, wherein said particle swarm optimizer further comprises means for repetitively updating the switching vector and the switching feedback gains.

7. The particle swarm optimizing sliding mode controller according to claim 6, further comprising means for determining when to stop repetitively updating the switching vector and the switching feedback gains.

8. The particle swarm optimizing sliding mode controller according to claim 7, wherein said circuit under control is an electric power generation system having a plurality of interconnected prime movers operating under automated generation control and subject to a generation rate constraint.

9. The particle swarm optimizing sliding mode controller according to claim 8, wherein said plurality of interconnected prime movers comprises at least one steam electrical generation plant.

10. The particle swarm optimizing sliding mode controller according to claim 8, further comprising means for minimizing frequency deviation among said interconnected prime movers under varying load conditions of the electrical power generation system.

11. The particle swarm optimizing sliding mode controller according to claim 8, further comprising means for minimizing tie-line power changes among the interconnected prime movers under varying load conditions of the electrical power generation system.

12. The particle swarm optimizing sliding mode controller according to claim 1, further comprising means for specifying a third set of parameters associated with said particle swarm optimizer.

13. The particle swarm optimizing sliding mode controller according to claim 1, wherein said particle swarm optimizer includes means for generating an initial population of particles, the particles forming a particle swarm.

14. The particle swarm optimizing sliding mode controller according to claim 13, further comprising means for repetitively simulating the swarm of particles.

15. The particle swarm optimizing sliding mode controller according to claim 14, further comprising:
means for establishing a cost function associated with the particle swarm;
means for discovering a fitness of each of the particles in the population based on the cost function;
means for updating position and velocity of each of the particles of successive ones of the repetitive particle simulations; and
means for terminating the particle position and velocity updating.
